(19) United States
(12) Patent Application Publication
(10) Pub. No.: US 2013/0092412 A1
(43) Pub. Date: Apr. 18, 2013

(54) CONNECTION STRUCTURE OF BRAIDED WIRE

(71) Applicants: Masahiro Tanaka, Makinohara-shi (JP); Hajime Kato, Makinohara-shi (JP)

(72) Inventors: Masahiro Tanaka, Makinohara-shi (JP); Hajime Kato, Makinohara-shi (JP)

(73) Assignee: YAZAKI CORPORATION, Tokyo (JP)

(21) Appl. No.: 13/806,494

(22) PCT Filed: Jul. 14, 2011
(86) PCT No.: PCT/JP2011/066102

§ 371 Date: Dec. 21, 2012

(30) Foreign Application Priority Data
Jul. 15, 2010 (JP) 2010-160491

(51) Int. Cl. H01B 5/12

(52) U.S. Cl. CPC H01B 5/12
USPC 174/78

(57) ABSTRACT

There is provided a ground structure of a braided wire having reduced the number of parts and the number of assembling processes and having improved a shield capability. A cylindrical part that is made to stand upright from a periphery of an insertion hole toward an outside of a device case is provided to the device case. A terminal of a 5 braid is put on an outer side of the cylindrical part of the device case and a shield band is wound on an outer side of the braid put on the outer side of the cylindrical part.

### DESCRIPTION

1. Technical Field

The invention relates to a connection structure of a braided wire, and more particularly, to a connection structure of a braided wire having a braided wire consisting of a covered electric wire and a cylindrical braid covering the covered electric wire and a device case having an insertion hole for inserting a connector attached to a terminal of the covered electric wire where the braid is connected to the device case.

2. Background Art

In a vehicle that is a moving object, electric wires are aligned so as to feed power from a power supply such as battery to devices such as various lamps and motors mounted on the vehicle and to transmit a control signal from a control device. Regarding the electric wires aligned in the vehicle, it has been known that braided wires are used due to measures against noise.

The braided wire has a covered electric wire and a cylindrical braid covering the covered electric wire and grounds the braid, so that noise leaked to the outside from the covered electric wire or noise originating from the outside collides with the braid and thus flows to the ground. As a result, it is possible to prevent the noise from being leaked and introduced. Regarding a ground structure of the braid of the braided wire, a ground structure has been known which connects the braid to an accommodation case of a device such as motor and thus grounds the same when connecting the braided wire to the device.

The ground structure of the braided wire is shown in FIGS. 14 to 16, for example (Patent Documents 1 to 3). As shown, a ground structure 101 of a braided wire includes a braided wire 102 that has a plurality of covered electric wires 121 and a cylindrical braid 122 collectively covering the covered electric wires 121 as a whole, a connector 103 that is attached to terminals of the covered electric wires 121, a metal shield shell 104 that is attached to the connector 103, a device case 105 that has an insertion hole 151 for inserting the connector 103 therein, and a terminal block 106 that is fixed in the device case 105.

The connector 103 includes a plurality of terminal fittings 131 that is clamped to cores of the respective covered electric wires 121 and a housing 132 made of resin that collectively accommodates the terminal fittings 131. The housing 132 has a plurality of terminal accommodation chambers that is penetrated in a longitudinal direction of the braided wire 102, and clamping parts with the cores of the terminal fittings 131 are inserted in the terminal accommodation chambers.

The shield shell 104 has a cylindrical shield shell main body 141 into which the housing 132 is inserted and a flange part 142 that protrudes from an outer surface of the shield shell main body 141. An outer side of the shield shell main body 141 is covered with a terminal of the cylindrical braid 122, and a braid crimping ring 107 is wound and crimped onto an outer side of the braid 122 put on the outer side of the shield shell main body 141. Thereby, it is possible to electrically connect the braid 122 and the shield shell 104.

The flange part 142 is formed with a plurality of bolt holes 143 for attaching and connecting the shield shell 104 to the device case 105 that is earthed to a ground (which will be described later). As shown in FIG. 15, by overlapping the flange part 142 with an outer surface of the device case 105 (which will be described later) and fastening the same with bolts 144, it is possible to electrically connect the shield shell 104 and the device case 105. That is, the braid 122 is connected to the device case 105 via the shield shell 104. Thereby, it is possible to ground the braid 122.

The device case 105 is formed with an insertion hole 151 for inserting the connector 103 attached to the terminal of the braid 122. The connector 103 is inserted into the device case 105 through the insertion hole 151. The terminal block 106 is formed with bolt holes 168 and is fastened with the device case 105 by bolts (not shown). Also, the terminal block 106 overlaps with the terminal fittings 131 of the connector 103 inserted through the insertion hole 151 and they are fastened by bolts 169.

In the below, a sequence of assembling the ground structure 101 of a braided wire configured as described above is described. First, the connector 103 is attached to the terminals of the covered electric wires 121 configuring the braided wire 102 and the shield shell 104 is attached to the connector 103. Then, the shield shell main body 141 is covered with the terminal of the braid 122 of the braided wire 102 and the braid crimping ring 107 is wound and crimped onto the outer side of the covered braid 122, so that the braid 122 and the shield shell 104 are connected. Also, the terminal block 106 is fixed in the device case 105 by the bolts.

Then, the connector 103 is inserted through the insertion hole 151, so that the terminal fittings 131 of the connector 103 are made to overlap with the terminal block 106 and the flange part 142 is made to overlap with the outer surface of the device case 105. Then, the flange part 142 is fastened to the device case 105 by the bolts 144 and the terminal fittings 131 are then fastened to the terminal block 106 by the bolts 169, so that the connector 103 and the shield shell 104 are fixed to the device case 105.

According to the above ground structure 101 of a braided wire, the shield shell 104 is required so as to ground the braid 122. Therefore, following problems occur. That is, the number of parts is increased, and the shield shell 104 should be fastened to the device case 105 by the bolts, so that the number of assembling processes is also increased.

Also, gaps are formed between the shield shell 104 and the housing 32 of the connector 103 and between the shield shell 104 and the device case 105, so that a shield capability is deteriorated. Additionally, it is necessary to provide a surface seal between the shield shell 104 and the device case 105 so as to secure waterproof and oilproof capabilities, which causes the increase in the number of parts and the number of assembling processes.

Also, according to the ground structure 101 of a braided wire, the connector 103 is fixed to the device case 105 by primarily fixing the shield shell 104 attached to the connector 103 to the device case 105 and then secondarily fixing the terminal fittings 131 to the terminal block 106. Like this, the bolt fastening is required so as to perform the primary fixing, which causes the increase in the number of assembling processes.

Also, as shown in FIG. 16, according to the ground structure 101 of a braided wire, the plurality of terminal fittings 131 is arranged side by side on a line. Thereby, a size of the arrangement direction of the terminal fittings 131 of the terminal block 106 is increased.

### PRIOR ART DOCUMENT

### Patent Documents

Patent Document 1: Japanese Patent Application Publication No. 2002-289307A

Patent Document 2: Japanese Patent Application Publication No. 2005-339933A

Patent Document 3: Japanese Patent Application Publication No. 2003-264040A

### SUMMARY OF INVENTION

### Problems to Be Solved by Invention

Accordingly, an object of the invention is to provide a ground structure of a braided wire having reduced the number of parts and the number of assembling processes and having improved a shield capability.

### Means for Solving Problems

The above problems are solved by following configurations.

(1) A ground structure of a braided wire including a braided wire having a covered electric wire and a cylindrical braid covering the covered electric wire, and a device case provided with an insertion hole for inserting a connector therein, the connector being attached to a terminal of the covered electric wire, wherein the braid is connected to the device case, wherein a cylindrical part that is made to stand upright from a periphery of the insertion hole toward an outside of the device case is provided to the device case, and wherein a terminal of the braid is put on an outer side of the cylindrical part of the device case, so that the braid and the device case are shield-connected.

(2) In the above (1), a housing of the connector is provided with a fitting part that is fitted in the cylindrical part, and a ring-shaped elastic seal is provided between an outer side of the fitting part and an inner side of the cylindrical part.

(3) In the above (1) or (2), a terminal block that is fixed in the device case is further provided, a locking lance having an arm that is bent in a diametrical direction of the braided wire and a locking protrusion that protrudes from the arm in the diametrical direction is provided to one of the terminal block and a housing of the connector, and a locking part that is locked to the locking protrusion is provided to the other of the terminal block and the housing of the connector.

(4) In the above (1) or (2), a terminal block that is fixed in the device case is further provided, and a housing of the connector is integrally formed with the terminal block that is fixed in the device case.

(5) In the above (1) or (2), a locking lance having an arm that is bent in a diametrical direction of the braided wire and a locking protrusion that protrudes from the arm in the diametrical direction is provided to one of a housing of the connector and the device case, and a locking part that is locked to the locking protrusion is provided to the other of the housing of the connector and the device case.

As described above, according to the ground structure of a braided wire having the configuration of the above (1), the terminal of the braid is put on the outer side of the cylindrical part provided to the device case, so that the braid and the device case are shield-connected. Thus, it is possible to omit a shield shell, thereby reducing the number of parts and the number of assembling processes. Also, the braid is directly put on the device case, so that the gaps between the shield shell and the connector and between the shield shell and the case are removed, contrary to the related art. Hence, the shield capability is improved.

According to the ground structure of a braided wire having the configuration of the above (2), the ring-shaped elastic seal is provided between the outer side of the fitting part provided to the housing of the connector and the inner side of the cylindrical part. Hence, it is possible to omit a surface seal and to secure the waterproof and oilproof capabilities by using the using the ring-shaped elastic seal that can be easily attached.

According to the ground structure of a braided wire having the configuration of the above (3), it is possible to fix the terminal block and the connector by the locking lance. Thus, it is not necessary to perform the bolt fastening so as to fix the terminal block and the connector, so that it is possible to reduce the number of assembling processes.

According to the ground structure of a braided wire having the configuration of the above (4), the terminal block and the connector are integrally formed. Thereby, it is not necessary to perform the fixing operation of the terminal block and the connector, so that it is possible to reduce the number of assembling processes. Also, it is not necessary to separately provide the terminal block from the connector, so that it is possible to reduce the number of parts.

According to the ground structure of a braided wire having the configuration of the above (5), it is possible to fix the connector and the device case by the locking lance. Therefore, it is not necessary to perform the bolt fastening so as to fix the connector and the device case, so that it is possible to reduce the number of assembling processes.

### BRIEF DESCRIPTION OF DRAWINGS

FIG. 1 is a perspective view showing a ground structure of a braided wire according to a first illustrative embodiment of the invention.

FIG. 2 is an exploded perspective showing the ground structure of a braided wire shown in FIG. 1, which is seen from a braided wire.

FIG. 3 is an exploded perspective showing the ground structure of a braided wire shown in FIG. 1, which is seen from a device case.

FIG. 4 is an upper view of covered electric wires and a connector attached to the covered electric wires, which configure the ground structure of a braided wire shown in FIG. 1.

FIG. 5 is a partial sectional view taken along a line I-I of FIG. 2.

FIG. 6 is a perspective view showing the ground structure of a braided wire shown in FIG. 1, which is seen from terminal fittings.

FIG. 7 is a schematic sectional view taken along a line II-II of FIG. 2.

FIG. 8A and FIG. 8B are a rear view and a front view of the connector 3 shown in FIG. 4, respectively.

FIG. 9 is a perspective view showing a ground structure of a braided wire according to a second illustrative embodiment of the invention.

FIG. 10 is a sectional view taken along a line III-III of FIG. 9.

FIG. 11 is a perspective view showing a ground structure of a braided wire according to a third illustrative embodiment of the invention.

FIG. 12 is an exploded perspective showing the ground structure of a braided wire shown in FIG. 11.

FIG. 13 is a sectional view taken along a line IV-IV of FIG. 11.

FIG. 14 is an exploded perspective showing a ground structure of a braided wire according to the related art.

FIG. 15 is a perspective view showing the ground structure of a braided wire shown in FIG. 14.

FIG. 16 is a perspective showing the ground structure of a braided wire shown in FIG. 15, which is seen from an inside of a device case.

### MODE TO CARRY OUT INVENTION

### First Illustrative Embodiment

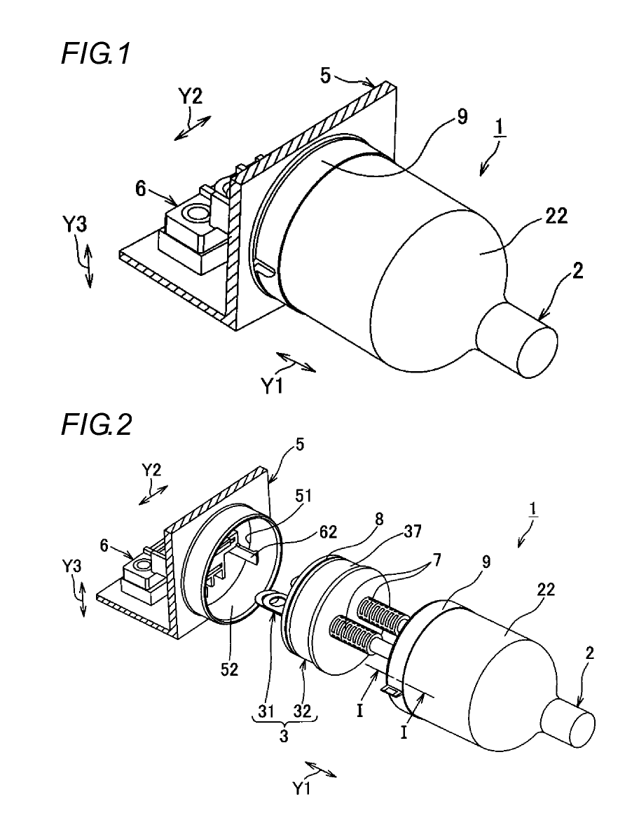

Hereinafter, a ground structure 1 of a braided wire according to a first illustrative embodiment of the invention will be described with reference to FIGS. 1 to 8B.

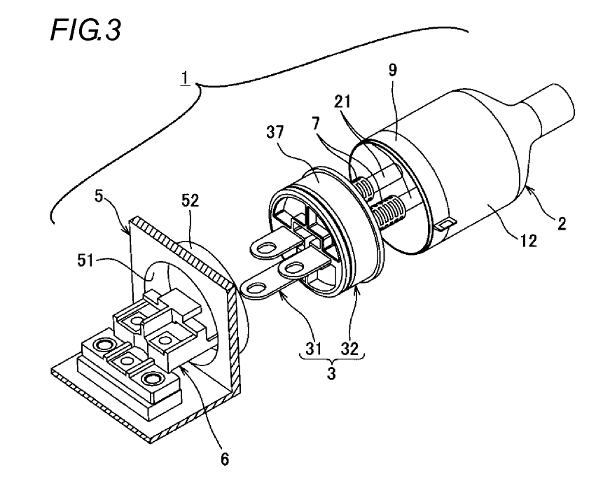

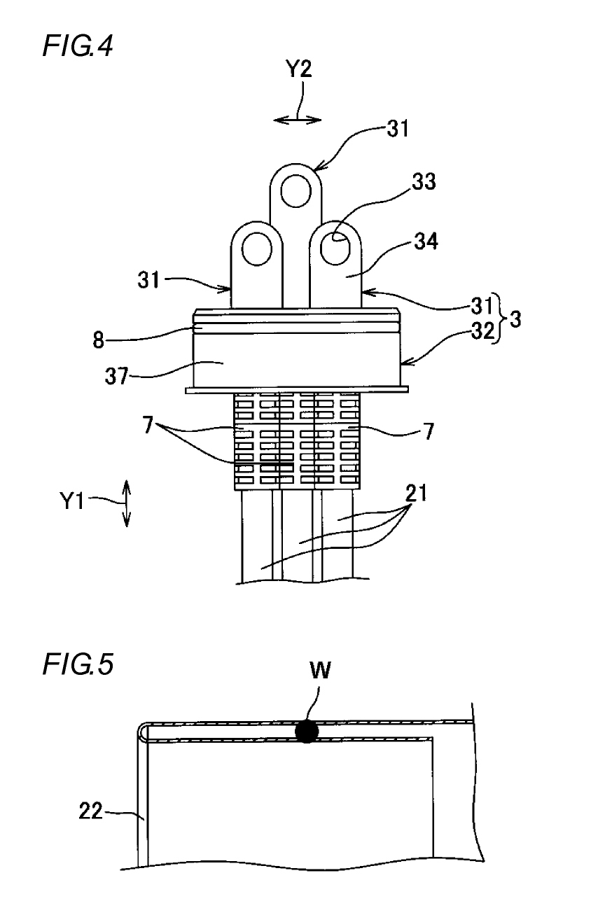

As shown in FIGS. 2 and 3, a ground structure 1 of a braided wire according to this illustrative embodiment includes a braided wire 2 having three covered electric wires 21 (refer to FIG. 4) and a cylindrical braid 22 collectively covering the covered electric wires 21 as a whole, a connector 3 that is attached to terminals of the covered electric wires 21, a device case 5 that has an insertion hole 51 for inserting the connector 3 therein, and a terminal block 6 that is fixed in the device case 5.

The covered electric wire 21 has a conductive core and an insulating covering part, which are not shown. The core (not shown) is formed by twisting one or more conductive wires. The covering part covers the core and is made of a synthetic resin such as polyvinyl chloride, for example.

The braid 22 is formed by braiding a plurality of conductive wires such as aluminum wires, stainless steel wires and the like into a cylindrical shape. An end portion of the braid 22 is enlarged so that an inner diameter thereof is larger than an outer diameter of a cylindrical part 52 of the device case 5 (which will be described later), so as to put the end portion on an outer side of the cylindrical part. Also, as shown in FIG. 5, the end portion of the braid 22 is folded outward and thus is doubly provided. The doubly overlapped parts of the braid 22 are welded (W) to each other by a seam welding, a spot welding, a soldering and the like.

As shown in FIGS. 2 to 4, the connector 3 has a plurality of metal terminal fittings 31 and a housing 32 made of a resin that collectively accommodates the terminal fittings 31. As shown in FIGS. 4, 6 and 7, regarding the terminal fitting 31, an LA terminal, for example, is used, and the terminal fitting has a flat plate-shaped tap terminal part 34 having a bolt hole 33 into which a bolt can be engaged and an electric wire connection part (not shown) that is clamped to the core (not shown) exposed at the terminal of the covered electric wire 21 and is electrically connected to the same, and extends in a longitudinal direction Y1 of the braided wire 2.

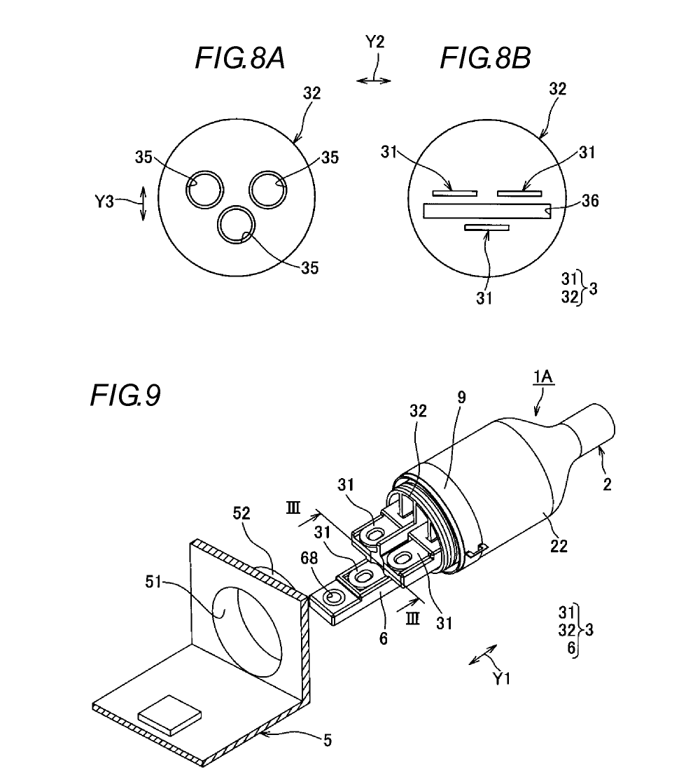

The housing 32 has a cylindrical shape and is provided with three terminal accommodation chambers 35 (refer to FIG. 8A) that are penetrated in the longitudinal direction Y1 of the braided wire 2, an attachment hole 36 (refer to FIGS. 7 and 8B) for inserting locking lances 62 of the terminal block 6 (which will be described later) and a fitting part 37 (refer to FIGS. 2 and 3) that is in a cylindrical part 52 of the device case 5 (which will be described later).

The three terminal accommodation chambers 35 accommodate the electrical connection parts of the three terminal fittings 31, respectively, and the tap terminal parts 34 protrude through an opening of the braided wire 2 at a leading end side with respect to the longitudinal direction Y1 and the covered electric wires 21 are withdrawn through an opening at a rear end side. As shown in FIGS. 2, 3, 4 and 7, reinforcement layers 7 are integrally molded to the electric wire connection parts of the terminal fittings 31 and outer sides of the covered electric wires 21 continuing to the electric wire connection parts. Then, the housing 32 is further over-molded to the outer sides of the covered electric wires 21 to which the reinforcement layers 7 are integrally molded.

Like this, the covered electric wires 21 are reinforced by molding the reinforcement layers 7 to the outer sides of the covered electric wires 21. In the meantime, regarding the reinforcement layer 7, a separate reinforcement layer may be provided from the covered electric wire 21, the separately provided reinforcement layer 7 may be put on the covered electric wire 21 and the housing 32 may be then over molded. Alternatively, a waterproof rubber plug may be mounted to the covered electric wire 21 and then inserted to the housing 32 that has been separately provided beforehand.

Also, as shown in FIGS. 8A and 8B, for example, the three terminal accommodation chambers 35 are arranged side by side in two stages in an upper-lower direction Y3 (a direction contacting/separating to/from the terminal block 6, i.e., a direction orthogonal to a mounting surface of the terminal fittings 31 to the terminal block 6). Specifically, two of the three terminal accommodation chambers 35 are arranged side by side at an upper stage distant from the terminal block 6 in a left-right direction Y2 (a direction orthogonal to both the longitudinal direction Y1 of the braided wire 2 and the upper-lower direction Y3) and one of the three terminal accommodation chambers 35 is arranged at a lower stage close to the terminal block 6. Also, the terminal accommodation chamber 35 of the lower stage is arranged between the two terminal accommodation chambers 35 of the upper stage.

The terminal fittings 31 are respectively accommodated in the terminal accommodation chambers 35. Thereby, the three terminal fittings 31 are held in the housing 32 so that they are arranged side by side in two stages in the upper-lower direction Y3. Also, the terminal fittings are held in the housing 32 so that two of the three terminal fittings 31 are arranged side by side in the left-right direction Y2 at the upper stage and one of the three terminal fittings 31 is arranged at the lower stage. Also, the terminal fitting 31 of the lower stage is arranged between the two terminal fittings 31 that are aligned at the upper stage. In addition, the terminal accommodation chambers 35 are formed so that the terminal fitting 31 of the lower stage is arranged at a more forward side than the terminal fittings 31 of the upper stage in the longitudinal direction Y1 of the braided wire 2.

As shown in FIG. 7, the attachment hole 36 has a shape that is recessed from the leading end of the housing 32 in the longitudinal direction Y1 and a pair of convex locking parts 39 that is respectively provided on an inner surface of the attachment hole and is locked to the locking lances 62 of the terminal block 6. The locking part 39 is inwardly tapered toward the read end side in the longitudinal direction Y1.

Also, as shown in FIG. 7, an outer periphery of the fitting part 37 is formed with a recess part 38, and a ring-shaped elastic seal 8 is fitted in the recess part 38. Like this, when inserted into the cylindrical part 52 with the elastic seal 8 being fitted, the ring-shaped elastic seal 8 is arranged between an outer side of the fitting part 37 and an inner side of the cylindrical part 52. A gap between the housing 32 and the cylindrical part 52 is plugged by the elastic seal 8, so that it is possible to prevent the water or oil from being introduced into the device case 5 through the gap between the housing 32 and the cylindrical part 52.

The device case 5 is a metal case that accommodates a device such as motor, to which the braided wire 2 is electrically connected, and is grounded. The device case 5 is provided with the circular insertion hole 51 that is penetrated inside and out and the cylindrical part 52 that is made to stand upright from the periphery of the insertion hole 51 toward the outside of the device case 5. As shown in FIGS. 1 to 3, the outer side of the cylindrical part 52 of the device case 5 is covered with the terminal of the braid 22, and a shield band 9 that is a band-shaped member is wound and crimped on the outer side of the braid 22 put on the outer side of the cylindrical part 52. The shield band 9 is made of a band-shaped metal plate and has a locking part that is locked to both ends of the metal plate.

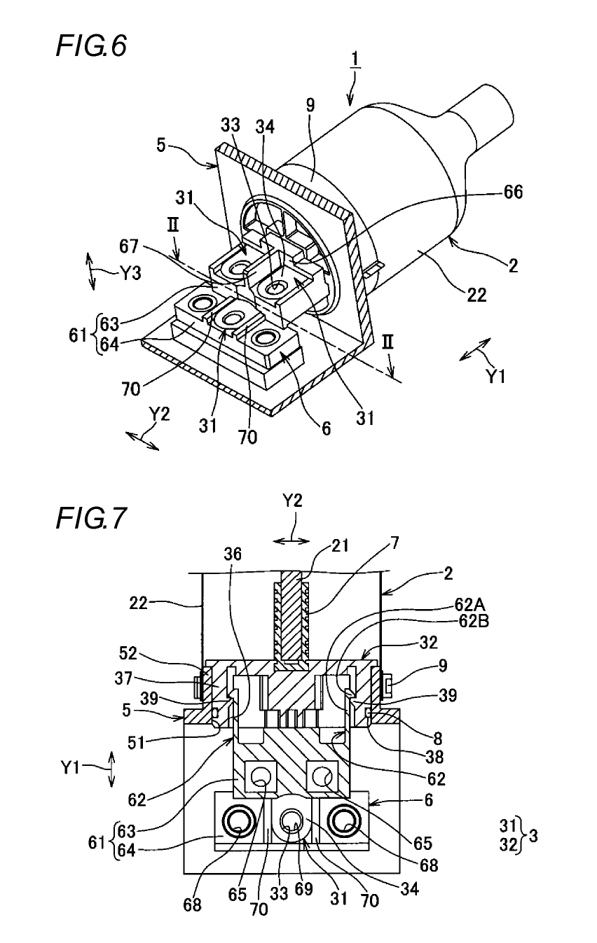

As shown in FIGS. 6 and 7, the terminal block 6 is formed of synthetic resin and the like and has a terminal block main body 61 that mounts the tap terminal parts 34 of the terminal fittings 31 and a pair of locking lances 62 for locking the terminal block 6 to the housing 32 of the connector 3. The terminal block main body 61 integrally has an upper stage terminal block main body 63 on which the tap terminal parts 34 of the terminal fittings 31 accommodated in the terminal accommodation chambers 35 of the upper stage are mounted and a lower stage terminal block main body 64 on which the tap terminal part 34 of the terminal fitting 31 accommodated in the terminal accommodation chamber 35 of the lower stage is mounted.

The upper stage terminal block main body 63 has a substantially rectangular parallelepiped shape. An upper surface of the upper stage terminal block main body 63, with which the tap terminal parts 34 overlap, is provided with bolt holes 65 (refer to FIG. 7) with which the bolt holes 33 of the tap terminal parts 34 overlap, an upstanding wall part 66 (refer to FIG. 6) that is provided to stand upright at the rear end of the braided wire 2 along the left-right direction Y2, and a partition wall part 67 that is provided along the longitudinal direction Y1 and separates the tap terminal parts 34 of the two terminal fittings 31, which are arranged at the upper stage, in the left-right direction Y2.

The upstanding wall part 66 is formed with terminal insertion holes (not shown) that are penetrated in the longitudinal direction Y1 and into which the tap terminal parts 34 of the terminal fittings 31 arranged at the upper stage are inserted. When the tap terminal parts 34 are inserted into the terminal insertion holes (not shown) formed at the upstanding wall part 66, the inserted tap terminal parts 34 can overlap with the upper surface of the upper stage terminal block main body 63.

The lower stage terminal block main body 64 has a substantially rectangular parallelepiped shape. An upper surface of the lower stage terminal block main body 64 has a rear end in the longitudinal direction Y1 that continues from a leading end of a lower surface of the upper stage terminal block main body 63 with respect to the longitudinal direction Y1. The upper surface of the lower stage terminal block main body 64, with which the tap terminal part 34 of the terminal block main body 64 overlaps, is formed with bolt holes 68 for bolt fastening into the device case 5, a bolt hole 69 that overlaps with the bolt hole 33 of the tap terminal part 34 and a pair of partition wall parts 70 that is provided to stand upright at left and right sides of the tap terminal part 34.

Also, a lower side of the upper stage terminal block main body 63 is formed with a terminal insertion hole (not shown) that is penetrated in the longitudinal direction Y1 and into which the tap terminal part 34 of the terminal fitting 31 arranged at the lower stage is inserted. When the tap terminal part 34 is inserted into the terminal insertion hole (not shown) formed at the upper stage terminal block main body 63, the inserted tap terminal part 34 can overlap with the upper surface of the lower stage terminal block main body 64.

By overlapping the bolt holes 65, 69 of the terminal block 6 with the bolt holes 33 of the tap terminal parts 34 and bolt holes of tap terminal parts of a counterpart connector (not shown) accommodated in the device case 5 and fastening bolts through the holes, it is possible to fix the terminal block 6 and the connector 3 and to electrically connect the tap terminal parts 34 and the tap terminal parts of the counterpart connector. Also, by inserting and fastening bolts (not shown) into the bolt holes 68 of the terminal block 6 and the bolt holes of the device case 5, it is possible to fix the terminal block 6 to the device case 5.

Also, the pair of locking lances 62 protrudes toward the rear end of the longitudinal direction Y1 from the upper stage terminal block main body 63 and is aligned side by side in the left-right direction Y2. As shown in FIG. 7, the pair of locking lances 62 has an arm 62A that is bent in a diametrical direction of the braided wire 2 and a locking protrusion 62B that protrudes from the arm 62A in a diametrically outer direction, respectively. The locking protrusion 62B is inwardly tapered toward the read end side in the longitudinal direction Y1. When the pair of locking lances 62 is inserted into the attachment hole 36 of the housing 32, the locking protrusions 62B and the locking parts 39 are locked, so that it is possible to attach the terminal block 6 to the housing 32.

Subsequently, a sequence of assembling the ground structure 1 of a braided wire according to the first illustrative embodiment is described. First, the inner diameter of the terminal of the braid 22 is beforehand made to be larger than the outer diameter of the cylindrical part 52 and is doubly provided by folding the same outward. Then, the doubly overlapped parts of the braid 22 are welded to each other by a seam welding, a spot welding, a soldering and the like so that the braid 22 is not loose.

Also, the covered parts of the terminals of the covered electric wires 21 are stripped to expose the cores and the exposed cores are clamped to the terminal fittings 31. Then, the terminal fittings 31 clamped to the cores are accommodated in the housing 32 and the connector 3 is attached to the terminals of the covered electric wires 21. Also, the terminal block 6 is mounted on the device case 5 so that the bolt holes 68 of the terminal block 5 overlap with the bolt holes (not shown) of the device case 5. Then, the bolts are inserted and fastened into the bolt holes (not shown) of the device case 5 and the bolt holes 68 of the terminal block 6, so that the terminal block 6 is fixed to the device case 5.

Then, the connector 3 is inserted through the insertion hole 51 of the device case 5. At this time, the fitting part 37 of the housing 32 is inserted into the cylindrical part 52, the locking lances 62 are inserted into the attachment hole 36 of the housing 32 and the tap terminal parts 34 are inserted into the terminal insertion holes (not shown) of the terminal block 6. By the insertion, when the locking protrusions 62B of the locking lances 62 reach the locking parts 39, the arms 62A are pushed by the locking parts 39 and thus inwardly bent, so that the arms are placed on the locking parts 39.

When the connector 3 is further inserted into the device case 5, the locking protrusions 62B go over the locking parts 39 and the arms 62A are thus restored outward, so that the locking protrusions 62B and the locking parts 39 are locked, as shown in FIG. 7. Thereby, the connector 3 is primarily fixed to the device case 5 via the terminal block 6. At this time, the tap terminal parts 34 are mounted onto the terminal block 6 at positions at which the bolt holes 33 of the tap terminal parts 34 and the bolt holes 65, 69 of the terminal block 6 overlap with each other.

Then, the tap terminal parts of the counterpart connector are made to overlap with the tap terminal parts 34 and the bolts are inserted and fastened into the bolt holes of the tap terminal parts of the counterpart connector, the bolt holes 33 of the tap terminal parts 34 and the bolt holes 65, 69 of the terminal block 6, so that the connector 3 is secondarily fixed to the device case 5 via the terminal block 6 and the tap terminals of the counterpart connector and the tape terminal parts 34 are electrically connected.

Then, the end portion of the braid 22 is put on the outer side of the cylindrical part 52, and the shield band 9 is wound and crimped onto the outer side of the braid 22 put on the outer side of the cylindrical part 52. Thereby, the braid 22 and the device case 5 are electrically connected and the braid 22 is grounded via the device case 5. Alternatively, the braid 22 may be connected to the cylindrical part 524 by the seam welding and the like from the outside.

According to the ground structure 1 of a braided wire of the first illustrative embodiment, the terminal of the braid 22 is put on the outer side of the cylindrical part 52 that is provided to the device case 5, and the shield band 9 is wound onto the outer side of the braid 22 put on the outer side of the cylindrical part 52. Therefore, it is possible to omit a shield shell, thereby reducing the number of parts and the number of assembling processes. Also, the braid 22 is directly put on the device case 5, so that the gaps between the shield shell and the connector and between the shield shell and the case are removed, contrary to the related art, and the shield capability is thus improved.

Also, according to the ground structure 1 of a braided wire of the first illustrative embodiment, the terminal of the braid 22 is folded and thus doubly provided and the doubly overlapped parts of the braid 22 are welded to each other. Therefore, it is possible to prevent the braid 22 from being loose until the braid 22 is earthed to the device case 5.

Also, according to the ground structure 1 of a braided wire of the first illustrative embodiment, the ring-shaped elastic seal 8 is provided between the outer side of the fitting part 37, which is provided to the housing 32 of the connector 3, and the inner side of the cylindrical part 52. Therefore, it is possible to omit a surface seal and to secure waterproof and oilproof capabilities by using the ring-shaped elastic seal 8 that can be easily attached.

Also, according to the ground structure 1 of a braided wire of the first illustrative embodiment, the locking lances 62, each of which has the arm 62A that is bent in the diametrical direction of the braid 22 and the locking protrusion 62B protruding from the arm 62A in the diametrical direction, are provided to the terminal block 6, and the locking parts 39 that are locked with the locking protrusions 62B are provided to the housing 32 of the connector 3. Thereby, it is possible to primarily fix the terminal block 6 and the connector 3 by the locking lances 62. Therefore, it is not necessary to perform the bolt fastening so as to primarily fix the terminal block 6 and the connector 3, so that it is possible to reduce the number of assembling processes.

Also, according to the ground structure 1 of a braided wire of the first illustrative embodiment, the terminal fittings 31 of the connector 3 are arranged side by side in two stages in the upper-lower direction Y3 that is a direction along which the connector is contacted/separated to/from the terminal block 6 fixed to the device case 5. Hence, compared to a configuration in which all the terminal fittings 31 are arranged in one stage, it is possible to reduce the size of the terminal block 6 in the left-right direction Y2. Also, the terminal fitting 31 of the lower stage close to the terminal block 6 is arranged at the more forward side in the longitudinal direction Y1 of the braided wire 2 than the terminal fittings 31 of the upper stage distant from the terminal block 6. Therefore, when bolting the terminal fitting 31 of the lower stage to the terminal block 6, the terminal fittings 31 of the upper stage do not interfere.

Also, according to the ground structure 1 of a braided wire of the first illustrative embodiment, the terminal fitting 31 of the lower stage close to the terminal block 6 is arranged between the two terminal fittings 31 of the upper stage distant from the terminal block 6. Therefore, it is possible to reduce the size of the terminal block 6 in the upper-lower direction Y3.

In the meantime, the ground structure 1 of a braided wire of the first illustrative embodiment is applied to the braided wire 2 that collectively covers the covered electric wires 21 as a whole by the braid 22. However, the invention is not limited thereto. For example, the invention can be also applied to the braided wire 2 that covers one covered electric wire 21 by the braid 22.

Also, according to the ground structure 1 of a braided wire of the first illustrative embodiment, the braid 22 has the end portion that is outward folded and is thus doubly provided. However, the invention is not limited thereto. For example, the end portion may be inward folded. Also, it is not necessary to fold and to doubly provide the end portion when there is no concern that the braid is loose.

Also, according to the ground structure 1 of a braided wire of the first illustrative embodiment, the terminal block 6 is provided with the locking lances 62 and the housing 32 of the connector 3 is provided with the locking parts 39 that are locked to the locking protrusions 62B of the locking lances 62. However, the invention is not limited thereto. For example, to the contrary, the housing 32 of the connector 3 may be provided with the locking lances 62 and the terminal block 6 may be provided with the locking parts 39.

Also, according to the ground structure 1 of a braided wire of the first illustrative embodiment, only one the terminal accommodation chamber 35 is provided at the lower stage. However, the invention is not limited thereto. For example, a plurality of terminal accommodation chambers 35 may be provided side by side at the lower stage in the left-right direction Y2. Also, the terminal accommodation chambers 35 may be provided in three or more stages as well as in two stages in the upper-lower direction.

Also, according to the ground structure 1 of a braided wire of the first illustrative embodiment, the LA terminal that can be bolt-fastened is used as the terminal fitting 31. However, the invention is not limited thereto. For example, regarding the terminal fitting 31, a terminal fitting that can be male-female fitted with a terminal fitting of the counterpart connector may be used. Also, in this case, the terminal block 6 is not required.

### Second Illustrative Embodiment

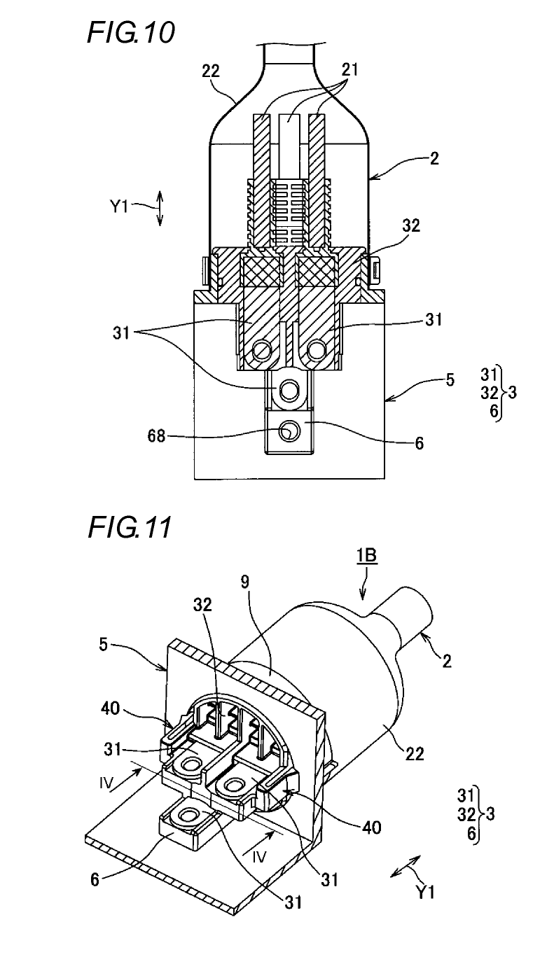

In the below, a ground structure 1A of a braided wire according to a second illustrative embodiment of the invention is described with reference to FIGS. 9 and 10. Meanwhile, in FIGS. 9 and 10, the parts equivalent to those described in the first illustrative embodiment with reference to FIGS. 1 to 8 are indicated with the same reference numerals and the detailed descriptions thereof are omitted. The first illustrative embodiment and the second illustrative embodiment are different regarding the structure of the terminal block 6. In the first illustrative embodiment, the housing 32 of the connector 3 and the terminal block 6 are separately provided and the terminal block 6 is attached to the housing 32 by the locking lances 62. In the second illustrative embodiment, the housing 32 of the connector 3 and the terminal block 6 are integrally provided by resin.

Also, according to the ground structure 1 of a braided wire of the first illustrative embodiment, the bolt holes 68 for attaching the terminal block 6 to the device case 5 are formed at the left and right sides of the tap terminal part 34 of the terminal fitting 31 that is accommodated in the terminal accommodation chamber 35 of the lower stage. Compared to this, according to the ground structure 1A of a braided wire of the second illustrative embodiment, the bolt hole 68 for attaching the terminal block 6 to the device case 5 is provided at a leading end side of the tap terminal part 34 of the terminal fitting 31, which is accommodated in the terminal accommodation chamber 35 of the lower stage, in the longitudinal direction Y1. Thereby, it is possible to easily insert the connector into the insertion hole 51 of the device case 5.

The sequence of assembling the ground structure 1A of a braided wire of the second illustrative embodiment is the same as that of the ground structure 1 of a braided wire of the first illustrative embodiment. First, like the first illustrative embodiment, the inner diameter of the terminal of the braid 22 is beforehand made to be larger than the outer diameter of the cylindrical part 52 and is doubly provided by folding the same outward. Then, the doubly overlapped parts of the braid 22 are welded to each other by a seam welding, a spot welding, a soldering and the like so that the braid 22 is not loose. Also, the connector 3 is attached to the terminals of the covered electric wires 21.

Then, the connector 3 is inserted through the insertion hole 51 of the device case 5. Then, the bolt hole 68 of the terminal block 6 that is integrally provided to the housing 32 is made to overlap with the bolt hole (not shown) of the device case 5. After that, the bolt is inserted and fastened into the bolt hole 68 of the terminal block 6 and the bolt hole (not shown) of the device case 5, which are made to overlap with each other, so that the device case 5 and the housing 32 of the connector 3 are fixed.

After that, the tap terminal parts of the counterpart connector are made to overlap with the tap terminal parts 34 and the bolts (not shown) are inserted and fastened into the bolt holes of the tap terminal parts of the overlapped counterpart connector, the bolt holes 33 of the tap terminal parts 34 and the bolt holes 65, 69 of the terminal block 6. Thereby, the connector 3 is fixed to the device case 5 via the terminal block 6 (secondary fixing) and the tap terminals of the counterpart connector and the tape terminal parts 34 are electrically connected.

Then, like the first illustrative embodiment, the end portion of the braid 22 is put on the outer side of the cylindrical part 52, and the shield band 9 is wound and crimped onto the outer side of the braid 22 put on the outer side of the cylindrical part 52. Thereby, the braid 22 and the device case 5 are electrically connected and the braid 22 is grounded via the device case 5.

According to the ground structure 1A of a braided wire of the second illustrative embodiment, the terminal block 6 and the connector 3 are integrally formed. Accordingly, since it is not necessary to perform the primary fixing operation of the terminal block 6 and the connector 3, it is possible to reduce the number of assembling processes. Also, since it is not necessary to separately provide the terminal block 6 from the connector 3, it is possible to reduce the number of parts.

### Third Illustrative Embodiment

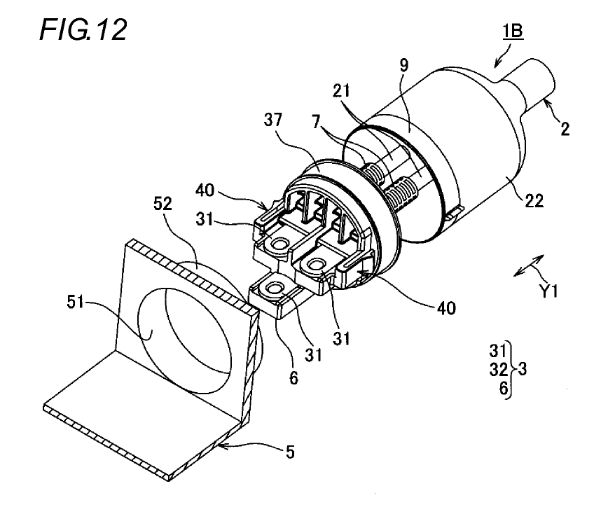

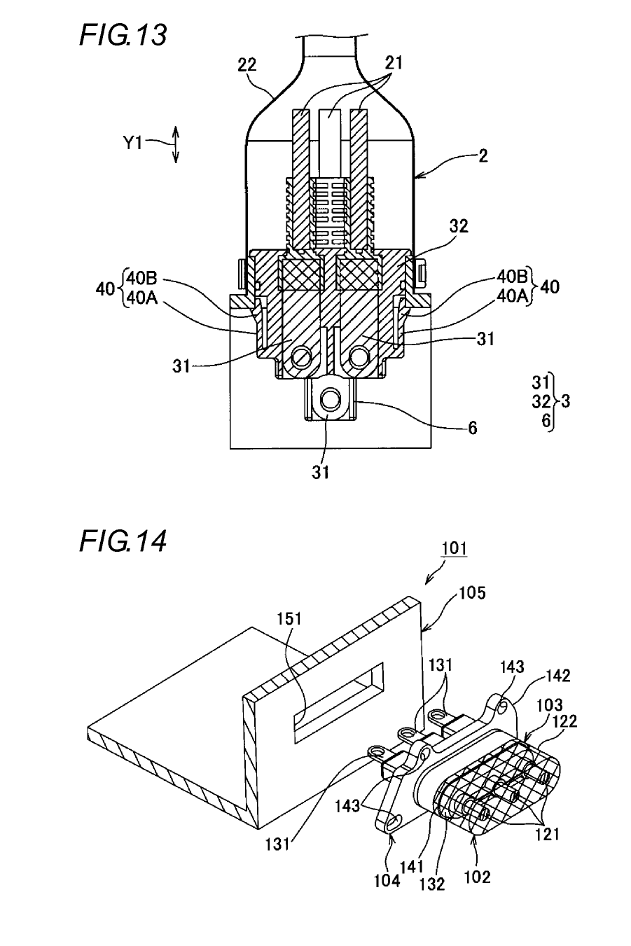

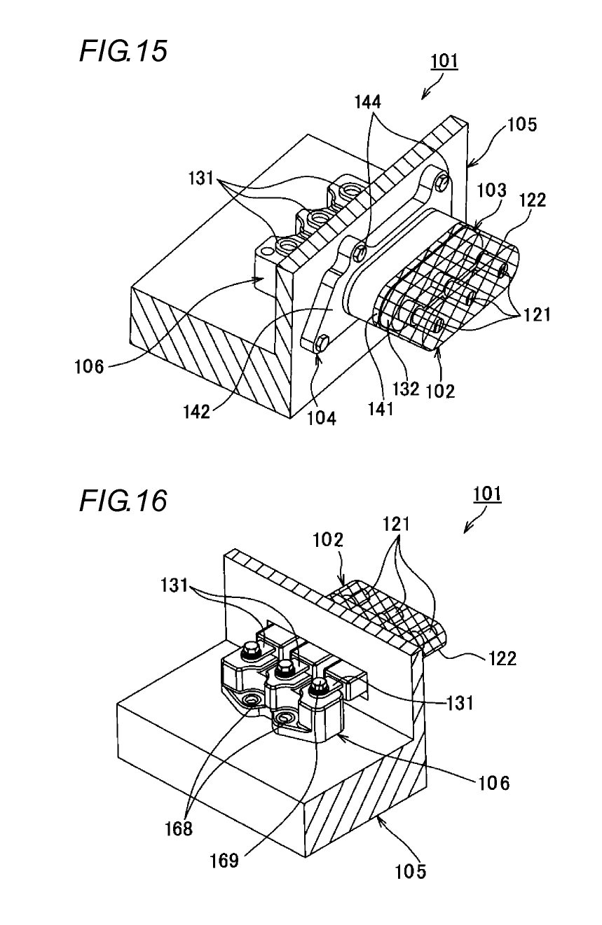

In the below, a ground structure 1B of a braided wire according to a third illustrative embodiment of the invention is described on the basis of FIGS. 11 to 13. Meanwhile, in FIGS. 11 to 13, the parts equivalent to those described in the second illustrative embodiment with reference to FIGS. 9 and 10 are indicated with the same reference numerals and the detailed descriptions thereof are omitted. The second illustrative embodiment and the third illustrative embodiment are different regarding the structure of the terminal block 6. In the second illustrative embodiment, the terminal block 6 is formed with the bolt hole 68 and is fixed to the device case 5 by the bolt fastening. In the third illustrative embodiment, the bolt hole 68 is omitted.

Instead of the bolt hole 68, locking lances 40 for locking to a periphery of the insertion hole 51 of the device case 5 are provided. The periphery of the insertion hole 51 of the device case 5 corresponds to the locking part of the claims. The locking lances 40 have a pair of arms 40A that is bent in the diametrical direction of the braided wire 2 and locking protrusions 40B that respectively protrude from the arms 40A in the diametrically outer direction. The arm 40A is provided along the longitudinal direction Y1 and has a leading end in the longitudinal direction Y1 that is connected to the outer side surface of the terminal block 6 and a rear end in the longitudinal direction Y1 that is diametrically bent.

The sequence of assembling the ground structure 1B of a braided wire of the third illustrative embodiment is the same as that of the second illustrative embodiment. First, like the ground structure 1A of a braided wire of the second illustrative embodiment, the inner diameter of the terminal of the braid 22 is beforehand made to be larger than the outer diameter of the cylindrical part 52 and is doubly provided by folding the same outward. Then, the doubly overlapped parts of the braid 22 are welded to each other by a seam welding, a spot welding, a soldering and the like so that the braid 22 is not loose. Also, the connector 3 is attached to the terminals of the covered electric wires 21.

Then, the connector 3 is inserted through the insertion hole 51 of the device case 5. By the insertion, when the locking protrusions 40B of the locking lances 40 reach the cylindrical part 52, the arms 40A are pushed by the inner surface of the cylindrical part 52, thus inwardly bent and then inserted into the cylindrical part 52. When the connector 3 is further inserted into the device case 5, the locking protrusions 40B comes out of the cylindrical part 52 and are inserted into the device case 5. Then, the periphery of the insertion hole 51 and the locking protrusions 40B are locked, so that the device case 5 and the terminal block 6 are relatively positioned and fixed.

After that, the tap terminal parts of the counterpart connector are made to overlap with the tap terminal parts 34 and the bolts (not shown) are inserted and fastened into the bolt holes of the tap terminal parts of the overlapped counterpart connector, the bolt holes 33 of the tap terminal parts 34 and the bolt holes 65, 69 of the terminal block 6. Thereby, the connector 3 is fixed to the device case 5 via the terminal block 6 (secondary fixing) and the tap terminals of the counterpart connector and the tape terminal parts 34 are electrically connected.

Then, like the second illustrative embodiment, the end portion of the braid 22 is put on the outer side of the cylindrical part 52, and the shield band 9 is wound and crimped onto the outer side of the braid 22 put on the outer side of the cylindrical part 52. Thereby, the braid 22 and the device case 5 are electrically connected and the braid 22 is grounded via the device case 5.

According to the ground structure 1B of a braided wire of the third illustrative embodiment, it is possible to fix the connector 3 and the device case 5 by the locking lances 40. Therefore, it is not necessary to perform the bolt fastening so as to fix the connector 3 and the device case 5, so that it is possible to reduce the number of assembling processes.

In the meantime, according to the ground structure 1B of a braided wire of the third illustrative embodiment, the connector 3 is provided with the locking lances 40 and the device case 5 is provided with the locking part. However, the invention is not limited thereto. For example, to the contrary, the device case 5 may be provided with the locking lances 40 and the connector 3 may be provided with the locking part.

Also, the above illustrative embodiments simply show the representative embodiments of the invention and the invention is not limited to the above illustrative embodiments. That is, it is possible to variously change the illustrative embodiments without departing from the gist of the invention.

In the meantime, this application is based on Japanese Patent Application (Patent Application No. 2010-160491) filed on Jul. 15, 2010, the disclosures of which are incorporated herein by reference.

### INDUSTRIAL APPLICABILITY

According to the ground structure of a braided wire of the invention, it is possible to provide a ground structure of a braided wire having reduced the number of parts and the number of assembling processes and having improved a shield capability.

### DESCRIPTION OF REFERENCE NUMERALS

1: ground structure of a braided wire

2: braided wire

3: connector

5: device case

6: terminal block

8: elastic seal

9: shield band (band-shaped member)

31: terminal fitting

32: housing

21: covered electric wire

22: braid

37: fitting part

39: locking part

40: locking lance

40A: arm

40B: locking protrusion

51: insertion hole

52: cylindrical part

62: locking lance

62A: arm

62B: locking protrusion

1. A ground structure of a braided wire comprising:
a braided wire having a covered electric wire and a cylindrical braid covering the covered electric wire, and
a device case provided with an insertion hole for inserting a connector therein, the connector being attached to a terminal of the covered electric wire,
wherein the braid is connected to the device case,
wherein a cylindrical part that is made to stand upright from a periphery of the insertion hole toward an outside of the device case is provided to the device case, and
wherein a terminal of the braid is put on an outer side of the cylindrical part of the device case, so that the braid and the device case are shield-connected.

2. The ground structure of the braided wire according to claim 1,
wherein a housing of the connector is provided with a fitting part that is fitted in the cylindrical part, and
wherein a ring-shaped elastic seal is provided between an outer side of the fitting part and an inner side of the cylindrical part.

3. The ground structure of the braided wire according to claim 1, further comprising a terminal block that is fixed in the device case,
wherein a locking lance having an arm that is bent in a diametrical direction of the braided wire and a locking protrusion that protrudes from the arm in the diametrical direction is provided to one of the terminal block and a housing of the connector, and
wherein a locking part that is locked to the locking protrusion is provided to the other of the terminal block and the housing of the connector.

4. The ground structure of the braided wire according to claim 1, further comprising a terminal block that is fixed in the device case,
wherein a housing of the connector is integrally formed with the terminal block that is fixed in the device case.

5. The ground structure of the braided wire according to claim 4,
wherein a locking lance having an arm that is bent in a diametrical direction of the braided wire and a locking protrusion that protrudes from the arm in the diametrical direction is provided to one of a housing of the connector and the device case, and
wherein a locking part that is locked to the locking protrusion is provided to the other of the housing of the connector and the device case.
